(19) United States
(12) Patent Application Publication
(10) Pub. No.: US 2015/0312465 A1
(43) Pub. Date: Oct. 29, 2015

(54) IMAGE CAPTURING STORAGE CONTAINER

(71) Applicant: FOREVER MINE MEDIA, G.P., Century City, CA (US)

(72) Inventors: Pejman Josef Javaheri, Los Angeles, CA (US); Jacob B. Ribakoff, II, Los Angeles, CA (US)

(73) Assignee: FOREVER MINE MEDIA, G.P., Century City, CA (US)

(21) Appl. No.: 14/262,386

(22) Filed: Apr. 25, 2014

(51) Int. Cl. H04N 5/232; H04N 5/91; H04N 5/225; H04N 5/77

(52) U.S. Cl. CPC H04N 5/23203; H04N 5/772; H04N 5/91; H04N 5/2252

(57) ABSTRACT

An image capturing apparatus including a storage container having a top cover and a base, the base having an outer front surface, the top cover of the storage container is pivotably attached to the base to allow for an open position and a closed position of the storage container and an image capturing unit disposed on the outer front surface of the base so that the image capturing unit can capture image data both in the open position and the closed position of the storage container.

### BACKGROUND OF THE INVENTION

1. Field of the Invention

The present invention relates to an image capturing storage container. In particular, the image capturing storage container allows a user to store a gift such as jewelry in the storage container and control recording when presenting the gift to another person from a unique perspective.

2. Description of the Related Art

A jewelry box is well known in the prior art and used to present jewelry to another person. A marriage proposal is a memorable event that people record in order to capture that special moment. U.S. Pat. No. 7,789,225 discusses mounting a recording device within the jewelry box in order to record a marriage proposal. In particular, the jewelry box begins recording when a user opens the lid of the jewelry box. In such a case, recording is limited to a period where the lid of the jewelry box is open.

Also known in the art are jewelry boxes that begin recording automatically when the jewelry box is opened. This is well known and is achieved using a sensor which adds to the cost and complexity of such a jewelry box. Furthermore, hiding some of the components within the jewelry box is problematic. For example, if the microphone is hidden within the jewelry box then capturing audio when the jewelry box is in a closed position may result in muffled audio. Also, when the microphone is hidden in the jewelry box, the top portion of the jewelry box may interfere with audio from the rear from the person presenting the jewelry box.

Thus there is a need in the art for an improved image capturing storage container that allows the user to retain more control of a recording.

### SUMMARY OF THE INVENTION

This invention relates to an image capturing storage container that a user can control to start and stop recording from an image capturing unit without requiring opening or closing of the image capturing storage container. The image capturing storage container may be used to record a special moment such as a marriage proposal by way of example. A gift such as jewelry may be stored within the image capturing storage container. The image capturing storage container includes an image capturing unit located on an outer front surface of a base of the image capturing storage container. The location of the image capturing unit allows for recording the presentation of a gift without requiring that the image capturing storage container be opened. Thus, recording of the presentation may be initiated prior to opening the image capturing storage container and may be continued while opening the image capturing storage container.

According to an aspect of the present invention, an image capturing apparatus includes a storage container having a top cover and a base, the base having an outer front surface. The top cover of the storage container is pivotably attached to the base to allow for an open position and a closed position of the storage container. The image capture apparatus also includes an image capturing unit disposed on the outer front surface of the base so that the image capturing unit can capture an image both in the open position and the closed position of the storage container.

Further features of the present invention will become apparent from the following description of exemplary embodiments with reference to the attached drawings.

### BRIEF DESCRIPTION OF THE DRAWINGS

FIG. 1 is a perspective view of an image capturing storage container in an open position according to an embodiment of the present invention.

FIG. 2 is a perspective view of the image capturing storage container of FIG. 1 in a closed position according to an embodiment of the present invention.

FIG. 3 is an exploded view of the image capturing storage container of FIG. 1 according to an embodiment of the present invention.

FIG. 4 is a rear perspective view of an image capturing storage container according to an embodiment of the present invention.

FIG. 5 is a block diagram illustrating an example configuration of a hardware configuration of the image capturing storage container according to an embodiment of the present invention.

### DESCRIPTION OF THE EMBODIMENTS

Various exemplary embodiments, features, and aspects of the invention will be described in detail below with reference to the drawings.

This invention relates to an image capturing apparatus for recording a user's reaction to opening a storage container which may contain a gift such as jewelry by way of example. The storage container portion may be a standard size and shape of a traditional jewelry box wherein a piece of jewelry may be inserted within the base of the image capturing apparatus. An image capturing unit is disposed on an outer front surface of the base of the storage container so that a user may begin recording prior to opening the storage container. Additionally, the user may end the recording before the storage container is placed in a closed position. Thus, recording may be controlled independent of the storage container opening or closing.

FIG. 5 is a block diagram illustrating one example of a hardware configuration of an image capturing apparatus of the present embodiment. The hardware configuration 100 includes a microprocessor 102 that is powered by a battery 104 and a power management device 106. An indicator light 108 such as a light emitting diode (LED) is used to indicate when the image capturing apparatus is powered on. The indicator light 108 may also indicate when the image capturing apparatus is being charged or when the image capturing apparatus is connected to a computer via a USE interface 114. Although a USE interface 114 is shown, this is by way of example and not of limitation. Other connection methods may be used for connecting the image capturing apparatus to a computer. A memory 110 for storing data and a computer program is coupled to the microprocessor 102. The hardware configuration 100 of the image capturing apparatus also includes a camera 112 for recording image data and or video data, a microphone 116, an audio component 118, a display driver 120, and a display 122.

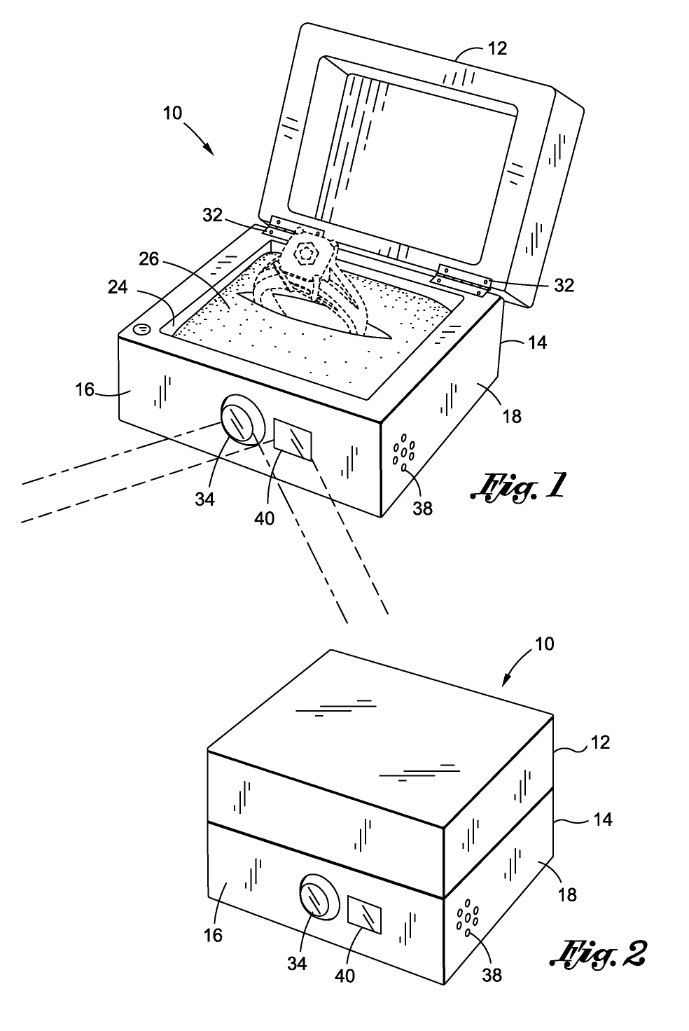

Referring now to FIG. 1, an image capturing apparatus 10 is shown. The image capturing apparatus 10 includes a top cover 12 and a base 14. The top cover 12 and the base 14 form a storage area 26 of the image capturing apparatus 10. The top cover 12 and the base 14 are pivotably attached to each other so that the image capturing apparatus 10 may be positioned in an open position or a closed position. The top cover 12 and the base 14 may be pivotably attached by a hinge 32 as shown in FIG. 1. However, other methods may be used to pivotably attach the base 14 and the top cover 12 of the image capturing apparatus 10.

The base 14 includes an outer front wall 16, a side wall 18, another side wall 20 opposing the side wall 18 and a rear wall 22 as shown in FIGS. 1, 3 and 4. The outer front wall 16, side walls 18, 20 and the rear wall 22 form the perimeter of the base 14 of the image capturing apparatus 10. The base 14 also includes an inner wall 24 adjacent the outer front wall 16, the side walls 18, 20 and the rear wall 22. The outer front wall 16 includes an image capturing unit 34. The image capturing unit 34 may also be disposed between the outer front wall 16 and the inner wall 24 of the base 14 of the image capturing apparatus 10. The outer front wall 16 of the base 14 may also include two grooves (not shown) on opposite sides of the image capturing unit 34 to warn the user when the user's fingers are nearing the image capturing unit 34 to avoid accidentally blocking the image capturing unit 34.

Still referring to FIG. 1, the image capturing unit 34 is configured to capture image data and/or video data. The image capturing unit 34 is disposed on the outer front wall 16 of the base 14 so that the image capturing unit 34 may record data when the image capturing apparatus 10 is in an open position or closed position. Thus, a user may begin recording an event prior to the image capturing apparatus 10 being placed in the open position. Furthermore, placing the image capturing unit 34 on the outer front wall 16 of the base 14 is advantageous because of the angle at which recording of the event takes place.

Adjacent the image capturing unit 34 is a forward facing light 40 also on the outer front wall 16 of the base 14 of the image capturing apparatus 10. The forward facing light 40 may be an LED light by way of example. The forward facing light allows for image capturing in low light situations. Alternatively, an infrared LEE) may be used to maintain a low light level.

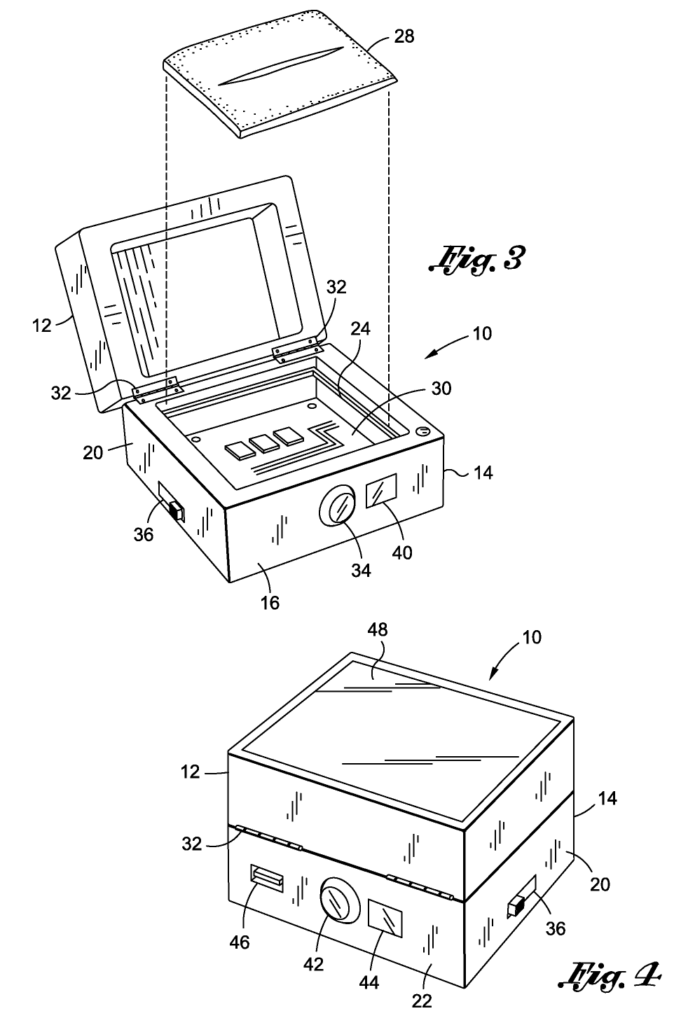

Referring to FIGS. 1 and 2, a microphone 38 is included on the side wall 18 of the base 14 of the image capturing apparatus 10. The placement of the microphone 38 on the side wall 18 is strategic in order to record audio from both the recipient of the gift stored in the storage area 26 of the image capturing apparatus 10 and a user who may be holding the image capturing apparatus 10 such that the rear wall 22 is facing the user. If the microphone 38 were placed on the inside of the storage area 26 such underneath the top cover 12, audio from a user may be obstructed by the top cover 12. Thus, placing the microphone on the side wall 18 allows for better recording of audio from all directions. En another embodiment, two microphones may be used, one microphone is placed on the front wall 16 and a second microphone is placed on the rear wall 22 in order to capture audio from both directions.

Referring now to FIG. 2, the image capturing apparatus 10 is in the closed position. The storage area 26 is hidden from view in the closed position. However, the image capturing unit 34 remains unobstructed and ready for recording upon being activated.

Referring now to FIG. 3, a power switch 36 is shown on the side wall 20 of the base 14 of the image capturing apparatus. The power switch 36 is used to power the image capturing apparatus 10 to record video, image and audio data via the image capturing unit 34 and the microphone 38. Data captured by the image capturing apparatus 10 may refer to either video and audio data, video data alone or audio data alone. Although the power switch 36 is shown in FIG. 3, a power on/off button may be used instead of the power switch 36. Alternatively, the image capturing apparatus 10 may be turned on wirelessly without physically having to switch the power switch 36. In one embodiment, is contemplated that the image capturing apparatus 10 may be turned on or off via a smartphone device through a wireless connection by way of example. In another embodiment, the image capturing apparatus 10 may be powered on by a voice command.

Still referring to FIG. 3, the electrical components 30 are hidden in the base 14 of the image capturing apparatus 10. The electrical components 30 are electrical components 30 of the image capturing apparatus 10 are hidden by a gift holder 28 which is stored within the storage area 26 of the image capturing apparatus 10. The gift holder 28 may be used to secure a piece of jewelry such as a ring, earrings, necklace by way of example. In another embodiment, a mechanism such as a lever (not shown) may be placed along the inner wall 24 of the base 14 opposing the image capturing unit 34 on the outer front wall 16. The lever (not shown) may be used to adjust the image capturing unit 34 to change the angle at which the image capturing unit 34 records image data and/or video data.

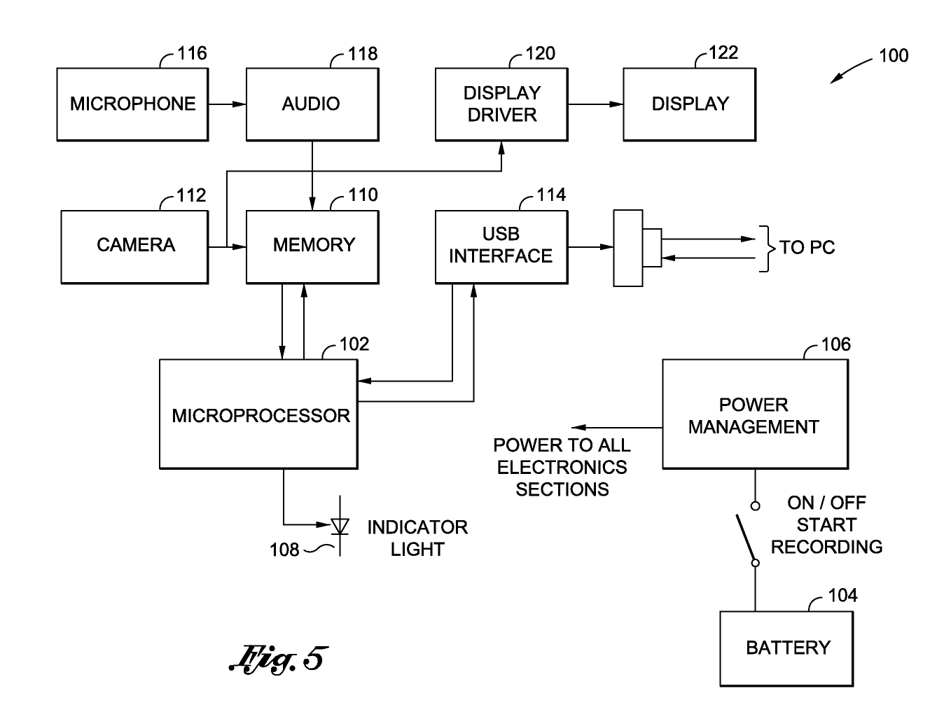

Referring now to FIG. 4, the rear wall 22 of the base 14 of the image capturing apparatus 10 is shown. Located on the rear wall 22 is a port 46 for connecting the image capturing apparatus 10 to a computer or for charging of the battery. The port 46 may be a USB port or any other acceptable port for allowing charging and data transfer between the image capturing apparatus 10 and a computer. Alternatively, data transfer may occur wirelessly. The battery may also be charged by way of a small external wall transformer. Alternatively, a non-rechargeable battery may also be used. The image capturing apparatus 10 is configured for reuse. The image capturing apparatus 10 can also be configured to erase data stored in order to reuse.

In another embodiment of the present invention, the image capturing apparatus 10 may include a rear facing image capturing unit. 42 that allows a user to simultaneously record the user as well a person in front of the image capturing unit 34. The rear wall 22 of the base 14 may also include a rear facing light 44 adjacent the rear facing image capturing unit 42 for enhancing simultaneous recording in low light situations. Although the rear facing image capturing unit 42 is provided, the image capturing apparatus 10 may be programmed so that only the image capturing unit 34 records data when activated by switching the power on via the power switch 36.

Still referring to FIG. 4, the image capturing apparatus 10 may also include a display 43 located on the top cover 12. The display 48 is configured to display the data being recorded by the image capturing unit 34 such that the user may adjust the image capturing apparatus 10 to record at a desired angle or view. The display 48 is configured as a viewfinder for the user. The display 48 may also be configured to display a split screen showing both the view of the image capturing unit 34 and the rear facing image capturing unit 42 if the rear facing image capturing unit 42 is included. The display 48 may also be used as a playback screen to view the recording. Alternatively, the display 48 may be disposed on a bottom portion of the base 14 of the image capturing apparatus 10 instead of on the top cover 12.

In another embodiment of the invention, the memory 110 includes a program for encrypting the data captured by the image capturing apparatus 10. The encryption is used to prevent playback of the captured event until a user is authenticated. Alternatively, the data captured by the image capturing apparatus 10 may be encrypted to allow for uploading of the data to a service site. The service site being configured to decrypt the data for a fee.

The image capturing apparatus 10 includes a storage medium which may include, for example, one or more of a hard disk, a random-access memory (RAM), read only memory (ROM), a storage of distributed computing systems, an optical disk (such as a compact disc (CD), digital versatile disc (DVD), or Blu-ray Disc (BD)™), a flash memory device, a memory card, and the like.

The current subject matter can provide many advantages. For example, discrete video capture or recording is not limited to a period where the image capturing apparatus 10 is in the open position. Audio can be captured from multiple directions, including originating from a forward facing position and a rearward facing position with respect to the image capturing apparatus 10. Additional control over the image capture and audio recording can be provided.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

While the present invention has been described with reference to exemplary embodiments, it is to be understood that the invention is not limited to the disclosed exemplary embodiments. Although a few variations have been described in detail above, other modifications are possible. For example, the implementations described above can be directed to various combinations and subcombinations of the disclosed features and/or combinations and subcombinations of several further features disclosed above. Other embodiments may be within the scope of the following claims.

What is claimed is:

1. An image capturing apparatus comprising:
a storage container having a top cover and a base, the base having an outer front surface, the top cover of the storage container is pivotably attached to the base to allow for an open position and a closed position of the storage container; and
an image capturing unit disposed on the outer front surface of the base so that the image capturing unit can capture image data in the open position and the closed position of the storage container.

2. The image capturing apparatus of claim 1, further comprising a power button in communication with the image capturing unit to allow for a user to start or stop image capturing.

3. The image capturing apparatus of claim 2, wherein the power button is disposed on a side wall of the base of the storage container.

4. The image capturing apparatus of claim 1, wherein the image capturing unit is activated wirelessly by a user.

5. The image capturing apparatus of claim 1, further comprising a microphone disposed on an outer surface of the base.

6. The image capturing apparatus claim 3, further comprising a microphone disposed on a side wall of the base opposite the side wall housing the power button.

7. The image capturing apparatus of claim 1, wherein data captured is encrypted to prevent a user from accessing the data without authorization.

8. The image capturing apparatus of claim 1, further comprising a display disposed on the top cover of the storage container for viewing images captured by the image capturing unit in real time.

9. The image capture apparatus of claim 1, further comprising a forward facing light disposed on the outer front surface of the base and adjacent to the image capturing unit.

10. The image capturing apparatus of claim 1, further comprising a rear facing image capturing unit disposed on a rear surface of the base below the hinge of the storage container.

11. The image capturing apparatus of claim 1, further comprising an adjustment mechanism disposed on an inner wall of the base of the storage container for adjusting an angle of the image capturing unit along a vertical axis.

12. The image capturing apparatus of claim 1, wherein the image capturing unit is a video camera.

13. The image capturing apparatus of claim 1, further comprising a voice activation unit to initiate image capturing based on a voice command.

14. The image capturing apparatus of claim 1, further comprising a port on the base portion for connecting and charging the image capturing apparatus.

15. A system comprising:
a storage container having a top cover pivotably attached to a base to allow for an open position and a closed position of the storage container, the storage container having an interior and an exterior; and
an image capturing unit disposed on the exterior of the base with an adjustable field of view configured to capture video of a forward proximate location, the image capturing unit configured to capture image data in the open position and the closed position of the storage container.
